(19) United States
(12) Patent Application Publication
(10) Pub. No.: US 2023/0224440 A1
(43) Pub. Date: Jul. 13, 2023

(54) ILLUMINATION SYSTEM AND PROJECTION APPARATUS

(71) Applicant: Coretronic Corporation, Hsin-Chu (TW)

(72) Inventors: Min-Chang Chang, Hsin-Chu (TW); Yu-Hsiang Deng, Hsin-Chu (TW)

(73) Assignee: Coretronic Corporation, Hsin-Chu (TW)

(21) Appl. No.: 18/152,780

(22) Filed: Jan. 11, 2023

(30) Foreign Application Priority Data
Jan. 13, 2022 (CN) 202210035633.0

(51) Int. Cl. H04N 9/31

(52) U.S. Cl. CPC H04N 9/3161; H04N 9/3155; H04N 9/3117

(57) ABSTRACT

An illumination system including a light source, a wavelength conversion device and a first light-uniforming element is provided. The light source emits an excitation beam. A light wavelength conversion region and a transmission region of the wavelength conversion device sequentially insert on the transmission path of the excitation beam at different time periods. When the light wavelength conversion region inserts on the transmission path of the excitation beam, a conversion beam is provided. When the transmission region inserts on the transmission path of the excitation beam, a non-conversion excitation beam is provided. The non-conversion excitation beam and the conversion beam penetrate the first light-uniforming element to form an illumination beam. The conversion beam is reflected for X time(s) and the non-conversion excitation beam is reflected for Y time(s) on the transmission path between the wavelength conversion device and the first light-uniforming element. A projection apparatus is also provided.

### CROSS-REFERENCE TO RELATED APPLICATION

This application claims the priority benefit of China application serial no. 202210035633.0 filed on Jan. 13, 2022. The entirety of the above-mentioned patent application is hereby incorporated by reference herein and made a part of this specification.

### BACKGROUND

### Technical Field

The present disclosure relates to an illumination system and a projection apparatus.

### Description of Related Art

A projector can provide a large display screen with a small size, and compared with a large-sized display, the projector can project images onto a large screen at a lower cost, so the projector plays an important role in the display field. The light combining assembly of the illumination system in the projector makes the excitation beam and the excited beam combine and enter the light-uniforming element to provide an illumination beam. A good light combining system can provide better efficiency and uniformity.

In the conventional technology, an anisotropic light-expanding element is further arranged in front of the wavelength conversion device in the illumination system, to adjust the spot of the excitation beam to be an anisotropic spot that matches the incident surface and light valve of the light-uniforming element light, such as rectangular or elliptical spots. In such cases, the excited beam will also have anisotropic spots. If the number of reflections performed to the excitation beam and the excited beam before the light-uniforming element is different, the long axes of the spot of the excitation beam and the excited beam on the light incident surface of the light-uniforming element might not be parallel. As a result, the spot of the excitation beam or the excited beam will not match the shape of the light incident surface of the light-uniforming element, the light-combining efficiency will be reduced, and the brightness, color and uniformity of the projector will be affected.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present disclosure provides an illumination system and a projection apparatus. The long axes of the spots of the excitation beam and the excited beam are substantially parallel, and the projection apparatus has high brightness, good color performance and good uniformity.

Other objects and advantages of the present disclosure can be further understood from the technical features disclosed in the present disclosure.

In order to achieve one or part or all of the above purposes or other purposes, according to an embodiment of the present disclosure, an illumination system is provided, and is configured to provide an illumination beam. The illumination system includes a light source, a wavelength conversion device and a first light-uniforming element. The light source emits an excitation beam. The wavelength conversion device includes at least one light wavelength conversion region and at least one transmission region. The light wavelength conversion region and the transmission region sequentially insert on the transmission path of the excitation beam at different time periods. When the light wavelength conversion region inserts on the transmission path of the excitation beam, the light wavelength conversion region converts the excitation beam into a conversion beam, and the conversion beam is reflected by the light wavelength conversion region. When the transmission region inserts on the transmission path of the excitation beam, the excitation beam passes through the transmission region and becomes a non-conversion excitation beam. The first light-uniforming element is arranged on the transmission path of the conversion beam and the non-conversion excitation beam. The illumination beam is formed after the non-conversion excitation beam and the conversion beam penetrate the first light-uniforming element. The conversion beam is reflected for X time(s) on the transmission path between the wavelength conversion device and the first light-uniforming element, and the non-conversion excitation beam is reflected for Y time(s) on the transmission path between the wavelength conversion device and the first light-uniforming element, and Y−X=2N and N is a positive integer greater than or equal to 1.

According to another embodiment of the present disclosure, a projection apparatus is provided, including an illumination system, a light valve, and a projection lens. The illumination system provides an illumination beam. The light valve is arranged on the transmission path of the illumination beam to convert the illumination beam into an image beam. The projection lens is arranged on the transmission path of the image beam to project the image beam out of the projection apparatus.

Based on the above, in the illumination system provided by the embodiment of the present disclosure, the conversion beam is reflected for X time(s) on the transmission path between the wavelength conversion device and the first light-uniforming element, and the non-conversion excitation beam is reflected for Y time(s) on the transmission path between the wavelength conversion device and the first light-uniforming element, and Y−X=2N and N is a positive integer greater than or equal to 1. As such, the long axes of spots of the non-conversion excitation beam and the conversion beam (excited beam) are substantially parallel to each other. The projections of both the non-conversion excitation beam and the conversion beam on the light-incident surface of the light-uniforming element match the shape of the light-incident surface of the light-uniforming element, and the light-combining efficiency is high. Therefore, the projection apparatus has high brightness, good color performance and good uniformity.

In order to make the above-mentioned features and advantages of the present disclosure more comprehensible, the following examples are given and described in detail with the accompanying drawings as follows.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate examples of the disclosure and, together with the description, serve to explain the principles of the disclosure.

FIG. 1A is a schematic view of an illumination system according to an embodiment of the present disclosure.

FIG. 1B is a schematic view of a wavelength conversion device according to an embodiment of the present disclosure.

FIG. 1C is a schematic view of a spot of an excitation beam according to an embodiment of the present disclosure.

FIG. 1D is a schematic view of the spot of the non-conversion excitation beam and the conversion beam on the light incident surface of the first light-uniforming element according to an embodiment of the present disclosure.

FIG. 2 is a schematic view of an illumination system according to an embodiment of the present disclosure.

FIG. 3 is a schematic view of an illumination system according to an embodiment of the present disclosure.

FIG. 4A is a schematic top view of an illumination system according to an embodiment of the present disclosure.

FIG. 4B is a schematic side view of the illumination system of the embodiment shown in FIG. 4A.

FIG. 4C is a schematic view of a light combining assembly according to an embodiment of the present disclosure.

FIG. 5 is a schematic view of an illumination system according to an embodiment of the present disclosure.

FIG. 6 is a schematic view of a projection apparatus according to an embodiment of the present disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of descript ion and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The foregoing and other technical contents, features and effects of the present disclosure will be clearly presented in the following detailed description of a preferred embodiment with reference to the drawings. The directional terms mentioned in the following embodiments, such as: up, down, left, right, front or rear, etc., are only for referring to the directions of the attached drawings. Accordingly, the directional terms used are illustrative and not limiting of the present disclosure.

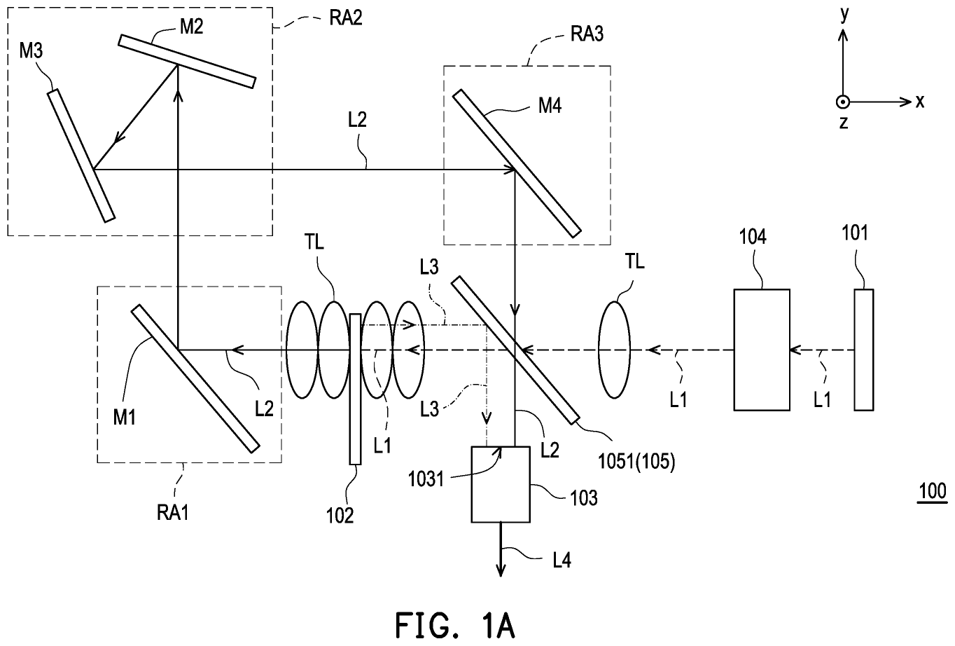

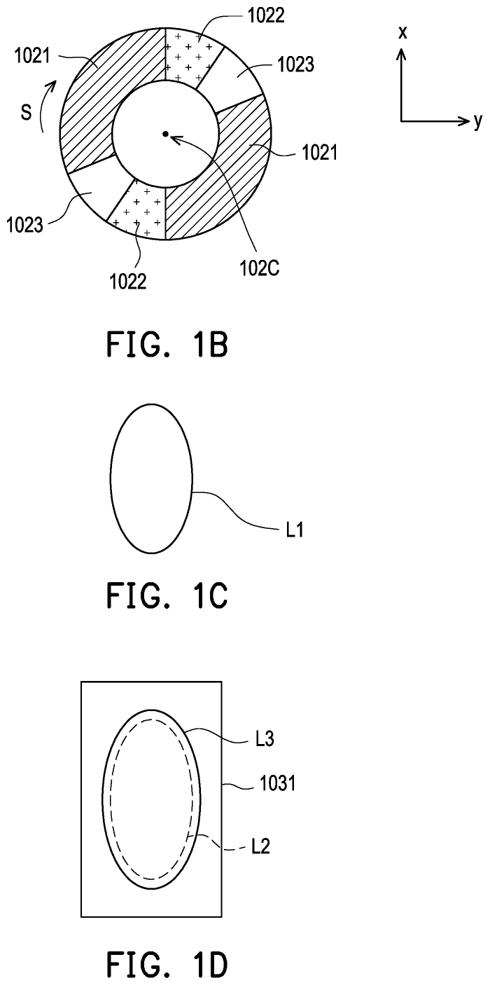

Referring to FIG. 1A and FIG. 1B, the illumination system 100 is configured to provide an illumination beam L4. The illumination system 100 includes a light source 101, a wavelength conversion device 102 and a first light-uniforming element 103. The light source 101 is, for example, an excitation light source, such as one or more laser diodes or light emitting diodes. The light source 101 is used to emit an excitation beam L1. The wavelength conversion device 102 includes light wavelength conversion regions 1021 and 1022 and a transmission region 1023. In this embodiment, the wavelength conversion device 10 includes, for example, a substrate (not shown and labeled), the light wavelength conversion regions 1021 and 1022 and the transmission region 1023 are adjacently arranged on the substrate, and the region of the substrate corresponding to the light wavelength conversion regions 1021 and 1022 are provided with a reflective layer. The wavelength conversion device 102 rotates around the central axis 102C in the direction S, so that the light wavelength conversion regions 1021 and 1022 and the transmission region 1023 sequentially insert on the transmission path of the excitation beam L1 at different time periods, and the direction S is, for example, clockwise. When the light wavelength conversion regions 1021 and 1022 sequentially insert on the transmission path of the excitation beam L1, the light wavelength conversion regions 1021 and 1022 convert the excitation beam L1 into a conversion beam L3, and the conversion beam L3 is reflected by the light wavelength conversion regions 1021 and 1022. When the transmission region 1023 inserts on the transmission path of the excitation beam L1, the excitation beam L1 passes through the transmission region 1023 of the wavelength conversion device 102 to form a non-conversion excitation beam L2. It should be noted that, for the ease of understanding, on the wavelength conversion device 102 in FIG. 1A, the conversion beam L3 and the excitation beam L1 are shown at different positions. Actually, the transmission paths of the conversion beam L3 reflected by the wavelength conversion device 102 and the excitation beam L1 incident on the wavelength conversion device 102 are at least partially overlapped.

According to an embodiment, the light wavelength conversion regions 1021 and 1022 may be respectively configured with wavelength conversion materials corresponding to different wavelength ranges. For example, the excitation beam L1 is a blue light beam. The excitation beam L1 incident on the light wavelength conversion region 1021 may be converted into a light beam in the red wavelength range, that is, the conversion beam L3 reflected by the light wavelength conversion region 1021 is a red light beam. The excitation beam L1 incident on the light wavelength conversion region 1022 may be converted into a light beam in the green wavelength range, that is, the conversion beam L3 reflected by the light wavelength conversion region 1022 is a green light beam. According to another embodiment, 1021 and 1022 may be configured with wavelength conversion materials corresponding to the same wavelength range. For example, the excitation beam L1 is a blue light beam. The excitation beam L1 incident on the light wavelength conversion regions 1021 and 1022 may be converted into light beams in the yellow wavelength range, that is, the conversion beams L3 reflected by the light wavelength conversion regions 1021 and 1022 are all yellow light beams.

Also referring to FIG. 1A, the first light-uniforming element 103 is disposed on the transmission paths of the conversion beam L3 and the non-conversion excitation beam L2. The illumination beam L4 is formed after a non-conversion excitation beam L2 and a conversion beam L3 penetrate the first light-uniforming element 103. In the illumination system 100 of this embodiment, the conversion beam L3 is reflected twice on the transmission path between the wavelength conversion device 102 and the first light-uniforming element 103, and the non-conversion excitation beam L2 is reflected for four times on the transmission path between the wavelength conversion device 102 and the first light-uniforming element 103. The difference in the number of times the conversion beam L3 and the non-conversion excitation beam L2 are reflected on the transmission path between the wavelength conversion device 102 and the first light-uniforming element 103 is 2 (even number).

Specifically, the illumination system 100 further includes a light combining assembly 105 and a light transmission assembly. The light combining assembly 105 includes a first dichroic element 1051. The first dichroic element 1051 is, for example, a dichroic mirror, the excitation beam L1 and the non-conversion excitation beam L2 with the same wavelength range may penetrate the first dichroic element 1051, and the conversion beam L3 with a different wavelength range may be reflected by the first dichroic element 1051. In this embodiment, the first dichroic element 1051 is, for example, a dichroic mirror that allows the blue light beam to pass through and reflects other light beams with different colors. In FIG. 1A, after the conversion beam L3 is reflected by the light wavelength conversion regions 1021 and 1022 of the wavelength conversion device 102, the conversion beam L3 is subsequently reflected by the first dichroic element 1051. Therefore, the conversion beam L3 is reflected twice on the transmission path between the wavelength conversion device 102 and the first light-uniforming element 103. The light transmission assembly includes mirrors M1, M2, M3 and M4 for guiding the non-conversion excitation beam L2 from the transmission region 1023 of the wavelength conversion device 102 to the first light-uniforming element 103. In detail, the non-conversion excitation beam L2 from the transmission region 1023 is sequentially reflected by the mirror M1, the mirror M2, the mirror M3, and the mirror M4, then penetrates the first dichroic element 1051 and enters the first light-uniforming element 103. Therefore, the non-conversion excitation beam L2 is reflected for four times on the transmission path between the wavelength conversion device 102 and the first light-uniforming element 103.

In this embodiment, the illumination system 100 further includes a second light-uniforming element 104, which is disposed on the transmission path of the excitation beam L1 and located between the light source 101 and the wavelength conversion device 102. In this embodiment, the second light-uniforming element 104 is an anisotropic light-uniforming element, and the second light-uniforming element 104 may be, for example, a microlens array, a wedge element, an anisotropic diffuser or the like. After the excitation beam L1 from the light source 101 penetrates the second light-uniforming element 104, the spot of the excitation beam L1 on the plane (Y-Z plane) perpendicular to a transmission direction (direction −X) of the excitation beam L1 is non-circularly symmetric, that is, the spot of the excitation beam L1 is a rectangular or elliptical spot having a long axis and a short axis, such as the elliptical spot shown in FIG. 1C. In such cases, the spots of the non-conversion excitation beam L2 and the conversion beam L3 emitted from the wavelength conversion device 102 on a plane perpendicular to the transmission direction thereof are also elliptical spots. As described above, since the difference in the number of times the conversion beam L3 and the non-conversion excitation beam L2 are reflected on the transmission path between the wavelength conversion device 102 and the first light-uniforming element 103 is 2 (even number), the long axis of the spot of the non-conversion excitation beam L2 and the long axis of the spot of the conversion beam L3 on the light incident surface 1031 of the first light-uniforming element 103 are substantially parallel to each other. With the proper configuration of the first light-uniforming element 103, the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area (as shown in FIG. 1D), so that the illumination system 100 may have good efficiency and uniformity.

The illumination system 100 may further include at least one lens TL disposed on the transmission paths of the excitation beam L1, the non-conversion excitation beam L2 and the conversion beam L3 to optimize the optical properties of the illumination beam L4. It should be noted that the non-circularly symmetric spot of the excitation beam L1 is not limited to the elliptical shape, and in other embodiments, the non-circularly symmetric spot of the excitation beam L1 may have a rectangular shape. In other embodiments, the second light-uniforming element 104 may also be an isotropic light-uniforming element.

In the present embodiment, the light transmission assembly is disposed on the transmission path of the non-conversion excitation beam L2 between the wavelength conversion device 102 and the first light-uniforming element 103. On the transmission path between the wavelength conversion device 102 and the first light-uniforming element 103, there are, for example, three reflection regions RA1, RA2, RA3, and the mirror M1 is located in the first reflection region RA1, for example, to change the transmission direction of the non-conversion excitation beam L2 from the wavelength conversion device 102 once. The mirrors M2 and M3 are located in the second reflection region RA2, for example, to change the transmission direction of the non-conversion excitation beam L2 from the first reflection region RA1 twice. The mirror M4 is located in the third reflection region RA3, for example, to change the transmission direction of the non-conversion excitation beam L2 from the second reflection region RA1 once, and subsequently the non-conversion excitation beam L2 passes through the first dichroic element 1051 and the first light-uniforming element 103. In other embodiments, two mirrors may be configured in the first reflection region RA1, or/and two mirrors may be configured in the third reflection region RA3. The present disclosure is not limited thereto, as long as the total number the non-conversion excitation beam L2 is reflected in the three reflection regions RA1, RA2, and RA3 on the transmission path between the wavelength conversion device 102 and the first light-uniforming element 103 is an even number, so that the difference in the number of times the conversion beam L3 and the non-conversion excitation beam L2 are reflected on the transmission path between the wavelength conversion device 102 and the first light-uniforming element 103 is a multiple of 2, they all fall within the scope of the present disclosure.

In order to fully illustrate the various embodiments of the present disclosure, other embodiments of the present disclosure will be described below. It should be noted here that the following embodiments use the element numbers and part of the contents of the previous embodiments, wherein the same numbers are used to represent the same or similar elements, and the description of the same technical contents is omitted. For the description of the omitted part, reference may be made to the foregoing embodiments, and the repetition will not be incorporated.

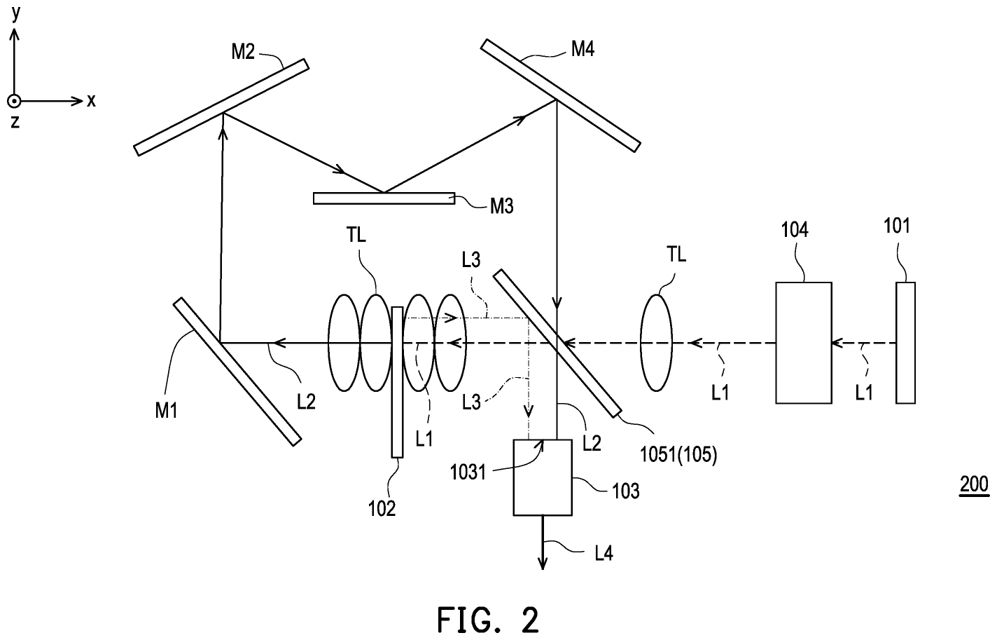

Referring to FIG. 2, the illumination system 200 includes a light source 101, a wavelength conversion device 102, a first light-uniforming element 103, a second light-uniforming element 104, a light combining assembly 105, and a light transmission assembly. The light combining assembly 105 includes a first dichroic element 1051. The light transmission assembly includes mirrors M1, M2, M3, and M4. The illumination system 200 of this embodiment is different from the illumination system 100 shown in FIG. 1A in the positions and orientations of the mirror M2 and the mirror M3. Specifically, the positions and orientations of the mirrors M1, M2, M3, and M4 may be adjusted according to requirements, and the positions and orientations of the mirrors M1, M2, M3, and M4 are not limited to those shown in FIG. 1A. The illumination system 200 of this embodiment may have a smaller size than the illumination system 100 shown in FIG. 1A.

In this embodiment, the conversion beam L3 is reflected twice on the transmission path between the wavelength conversion device 102 and the first light-uniforming element 103, and the non-conversion excitation beam L2 is reflected for four times on the transmission path between the wavelength conversion device 102 and the first light-uniforming element 103. The difference in the number of times the conversion beam L3 and the non-conversion excitation beam L2 are reflected on the transmission path between the wavelength conversion device 102 and the first light-uniforming element 103 is 2.

Since the difference in the number of times the conversion beam L3 and the non-conversion excitation beam L2 are reflected on the transmission path between the wavelength conversion device 102 and the first light-uniforming element 103 is 2 (even number), the long axis of the spot of the non-conversion excitation beam L2 on the light incident surface 1031 of the first light-uniforming element 103 is substantially parallel to the long axis of the spot of the conversion beam L3. With the proper configuration of the first light-uniforming element 103, the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area, so that the illumination system 200 may have good efficiency and uniformity.

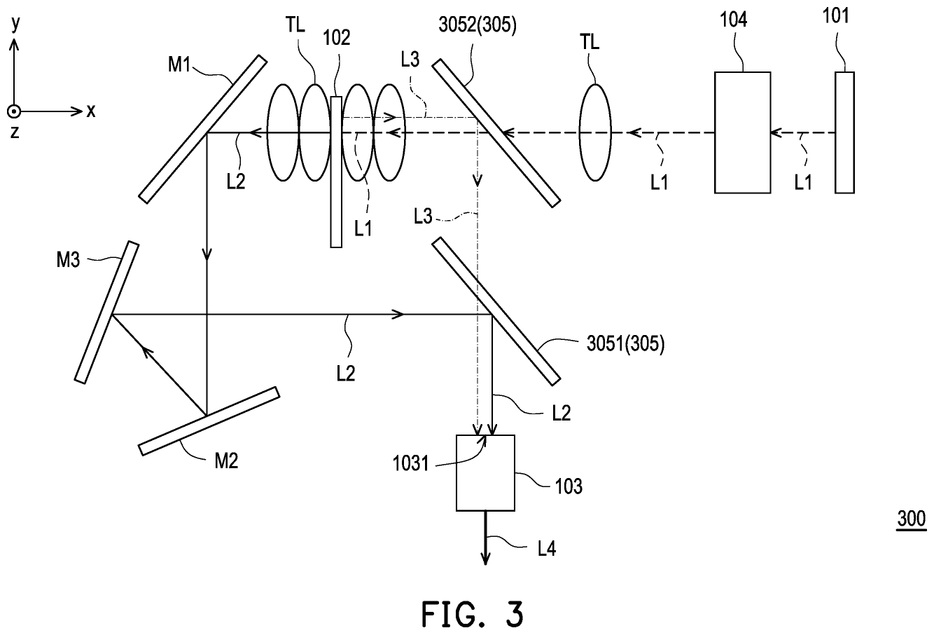

Referring to FIG. 3, the illumination system 300 includes a light source 101, a wavelength conversion device 102, a first light-uniforming element 103, a second light-uniforming element 104, a light combining assembly 305, and a light transmission assembly. The light combining assembly 305 includes a first dichroic element 3051 and a second dichroic element 3052. The first dichroic element 3051 and the second dichroic element 3052 are, for example, dichroic mirrors. In this embodiment, the first dichroic element 3051 is, for example, a dichroic mirror that reflects blue light beams and allows light beams of other colors to pass through, and the second dichroic element 3052 is, for example, a dichroic mirror that allows blue light beams to pass through and reflects light beams of other colors. The excitation beam L1 may penetrate the second dichroic element 3052, and the conversion beam L3 may be reflected by the second dichroic element 3052. The non-conversion excitation beam L2 from the wavelength conversion device 102 may be reflected by the first dichroic element 3051 after passing through the light transmission assembly, and the conversion beam L3 from the second dichroic element 3052 may penetrate the first dichroic element 3051. The light transmission assembly includes mirrors M1, M2, and M3.

Please refer to FIG. 3 and FIG. 1B both, the light source 101 emits an excitation beam L1. The second light-uniforming element 104 is an anisotropic light-uniforming element. After penetrating the second light-uniforming element 104, the spot of the excitation beam L1 on the plane (Y-Z plane) perpendicular to the transmission direction (direction −X) of the excitation beam L1 is non-circularly symmetric. After the excitation beam L1 penetrates the second dichroic element 3052, the excitation beam L1 enters the wavelength conversion device 102. When the light wavelength conversion regions 1021 and 1022 insert on the transmission path of the excitation beam L1, the light wavelength conversion regions 1021 and 1022 convert the excitation beam L1 into a conversion beam L3, and the conversion beam L3 is reflected by the light wavelength conversion regions 1021 and 1022. When the transmission region 1023 inserts on the transmission path of the excitation beam L1, the excitation beam L1 penetrates the transmission region 1023 and forms a non-conversion excitation beam L2.

The conversion beam L3 reflected by the light wavelength conversion regions 1021 and 1022 is reflected by the second dichroic element 3052, penetrates the first dichroic element 3051, and enters the first light-uniforming element 103. Therefore, the conversion beam L3 is reflected twice on the transmission path between the wavelength conversion device 102 and the first light-uniforming element 103. The non-conversion excitation beam L2 from the transmission region 1023 is sequentially reflected by the mirror M1, the mirror M2, and the mirror M3, then reflected by the first dichroic element 3051 and enters the first light-uniforming element 103. Therefore, the non-conversion excitation beam L2 is reflected for four times on the transmission path between the wavelength conversion device 102 and the first light-uniforming element 103. The difference in the number of times the conversion beam L3 and the non-conversion excitation beam L2 are reflected on the transmission path between the wavelength conversion device 102 and the first light-uniforming element 103 is 2.

Since the difference in the number of times the conversion beam L3 and the non-conversion excitation beam L2 are reflected on the transmission path between the wavelength conversion device 102 and the first light-uniforming element 103 is 2 (even number), the long axis of the spot of the non-conversion excitation beam L2 on the light incident surface 1031 of the first light-uniforming element 103 is substantially parallel to the long axis of the spot of the conversion beam L3. With the proper configuration of the first light-uniforming element 103, the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area, so that the illumination system 300 may have good efficiency and uniformity.

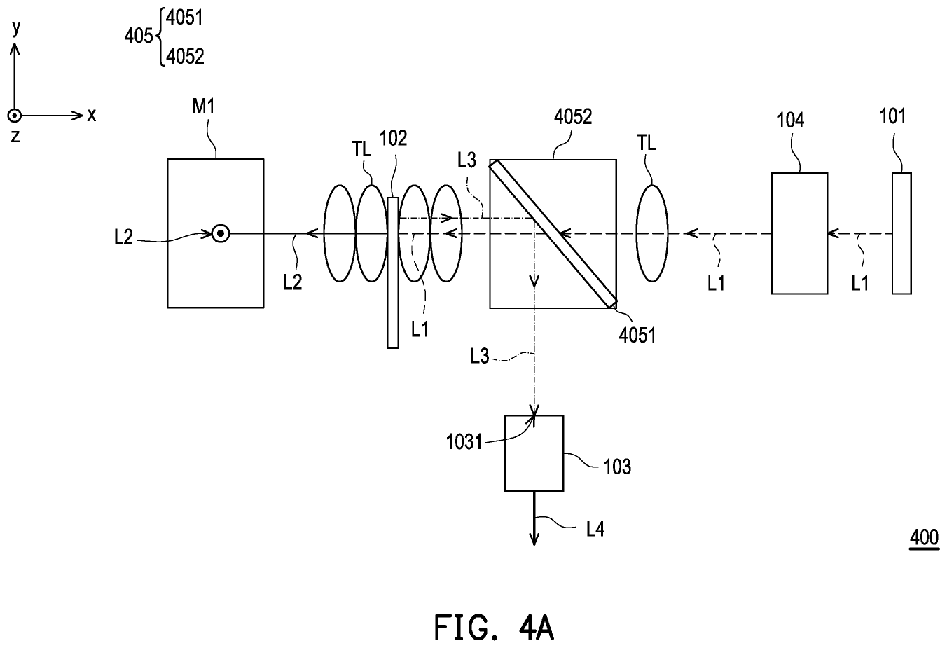

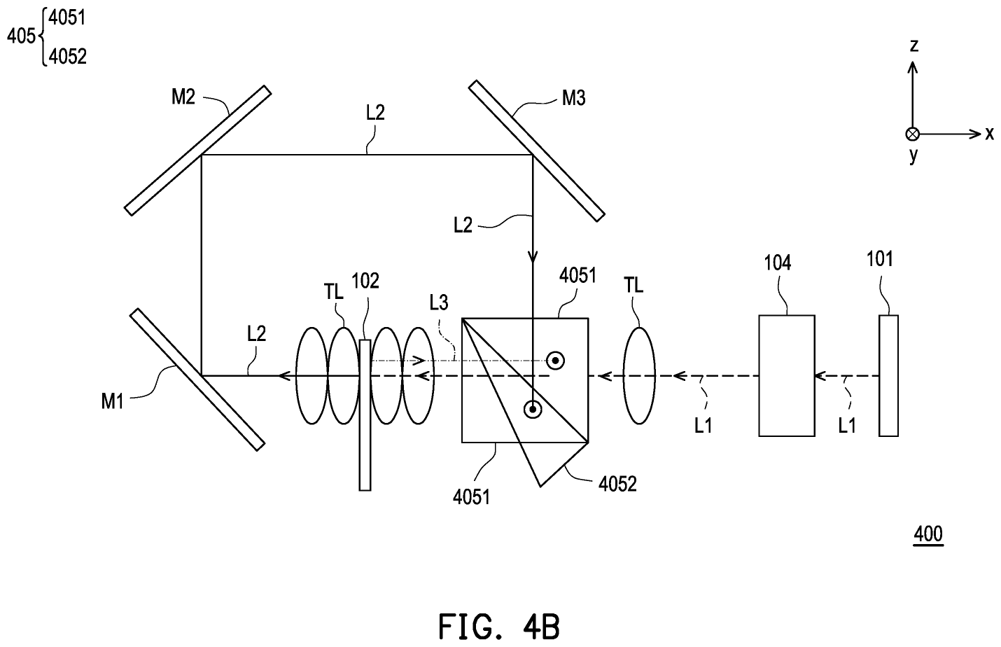

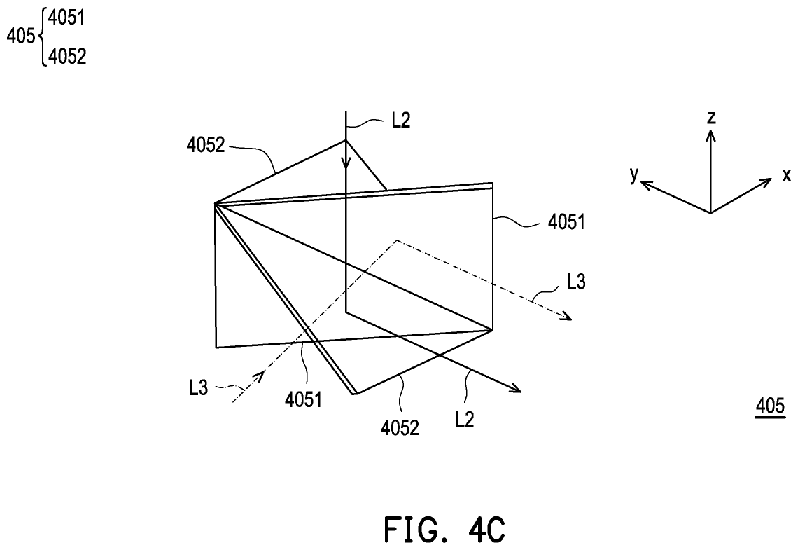

Referring to FIG. 4A to FIG. 4C, the illumination system 400 includes a light source 101, a wavelength conversion device 102, a first light-uniforming element 103, a second light-uniforming element 104, a light combining assembly 405, and a light transmission assembly. The light combining assembly 405 includes a first dichroic element 4051 and a reflective element 4052. The first dichroic element 4051 is, for example, a dichroic mirror, such as a dichroic mirror for allowing the blue light beam to pass through and reflecting the light beams of other colors. The excitation beam L1 may penetrate the first dichroic element 4051. The conversion beam L3 may be reflected by the first dichroic element 4051. The reflective element 4052 is, for example, a mirror. The light transmission assembly includes mirrors M1, M2, and M3.

Please refer to FIG. 4A, FIG. 4B and FIG. 1B. For the ease of understanding, FIG. 4A is a schematic view of a part of the structure of the illumination system 400, and the mirrors M2 and M3 and the transmission path of the non-conversion excitation beam L2 reflected from the mirror M1 are not shown. The light source 101 emits an excitation beam L1. The second light-uniforming element 104 is an anisotropic light-uniforming element. After penetrating the second light-uniforming element 104, the spot of the excitation beam L1 on the plane (Y-Z plane) perpendicular to the transmission direction (direction −X) of the excitation beam L1 is non-circularly symmetric. After the excitation beam L1 penetrates the first dichroic element 4051 along the direction −X, the excitation beam L1 enters the wavelength conversion device 102. When the light wavelength conversion regions 1021 and 1022 insert on the transmission path of the excitation beam L1, the light wavelength conversion regions 1021 and 1022 convert the excitation beam L1 into a conversion beam L3, and the conversion beam L3 is reflected by the light wavelength conversion regions 1021 and 1022. When the transmission region 1023 inserts on the transmission path of the excitation beam L1, the excitation beam L1 penetrates the transmission region 1023 to form a non-conversion excitation beam L2.

The conversion beam L3 is reflected by the light wavelength conversion regions 1021 and 1022 and then travels in the direction X, and is reflected by the first dichroic element 4051 and then travels in the direction −Y, and enters the first light-uniforming element 103. Therefore, the conversion beam L3 is reflected twice on the transmission path between the wavelength conversion device 102 and the first light-uniforming element 103. The non-conversion excitation beam L2 is sequentially reflected by the mirror M1, the mirror M2, and the mirror M3 on the transmission path between the wavelength conversion device 102 and the first light-uniforming element 103, and then reflected by the reflective element 4052 and enters the first light-uniforming element 103 (reflected for 4 times in total). Specifically, the non-conversion excitation beam L2 traveling in the direction −X is reflected by the mirror M1 and then travels toward the direction Z. The non-conversion excitation beam L2 traveling in the direction Z is reflected by the mirror M2 and then travels in the direction X. The non-conversion excitation beam L2 traveling in the direction X is reflected by the mirror M3 and then travels in the direction −Z. The non-conversion excitation beam L2 traveling in the direction −Z is reflected by the reflective element 4052 of the light combining assembly 405 and then travels in the direction −Y, and enters the first light-uniforming element 103. The difference in the number of times the conversion beam L3 and the non-conversion excitation beam L2 are reflected on the transmission path between the wavelength conversion device 102 and the first light-uniforming element 103 is 2.

Since the difference in the number of times the conversion beam L3 and the non-conversion excitation beam L2 are reflected on the transmission path between the wavelength conversion device 102 and the first light-uniforming element 103 is 2 (even number), the long axis of the spot of the non-conversion excitation beam L2 and the long axis of the spot of the conversion beam L3 on the light incident surface 1031 of the first light-uniforming element 103 are substantially parallel to each other. With the proper configuration of the first light-uniforming element 103, the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area, so that the illumination system 400 may have good efficiency and uniformity.

In this embodiment, the first dichroic element 4051 is arranged along the diagonal line of the reflective element 4052, and the reflective element 4052 is arranged along the diagonal line of the first dichroic element 4051, so the first dichroic element 4051 and the reflective element 4052 are arranged in an X-shaped configuration.

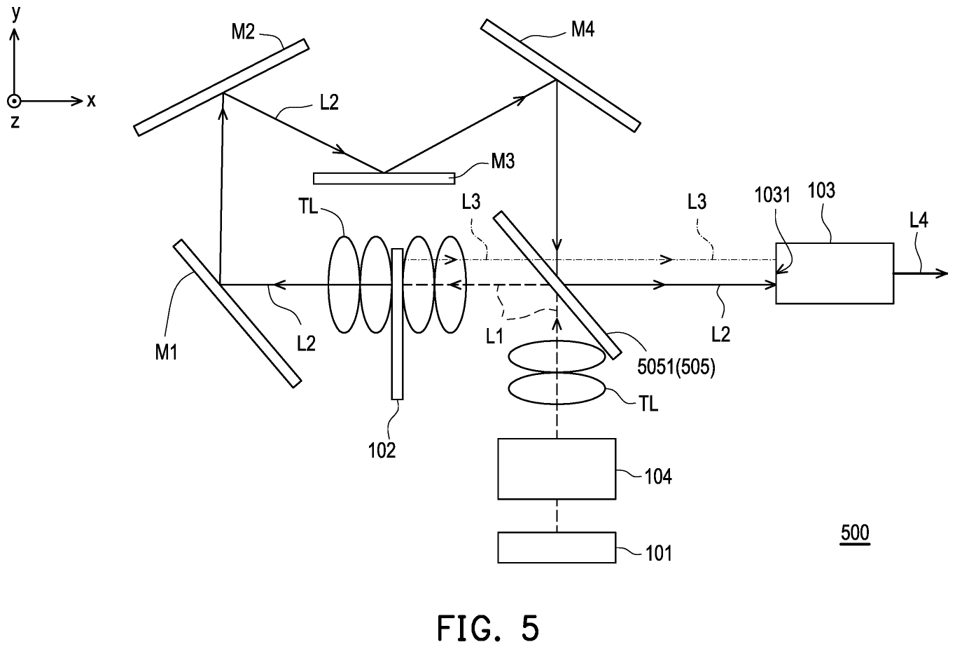

Referring to FIG. 5, the illumination system 500 includes a light source 101, a wavelength conversion device 102, a first light-uniforming element 103, a second light-uniforming element 104, a light combining assembly 505, and a light transmission assembly. The light combining assembly 505 includes a first dichroic element 5051. The first dichroic element 5051 is, for example, a dichroic mirror. The excitation beam L1 and the non-conversion excitation beam L2 having the same wavelength range may be reflected by the first dichroic element 5051. The conversion beam L3 having a different wavelength range may penetrate the first dichroic element 5051. The light transmission assembly includes mirrors M1, M2, M3, and M4.

Please refer to FIG. 5 and FIG. 1B at the same time, the light source 101 emits an excitation beam L1. The second light-uniforming element 104 is an anisotropic light-uniforming element. After penetrating the second light-uniforming element 104, the spot of the excitation beam L1 on the plane (X-Z plane) perpendicular to the transmission direction (direction Y) of the excitation beam L1 is non-circularly symmetric. After the excitation beam L1 is reflected by the first dichroic element 5051, the excitation beam L1 enters the wavelength conversion device 102. When the light wavelength conversion regions 1021 and 1022 insert on the transmission path of the excitation beam L1, the light wavelength conversion regions 1021 and 1022 convert the excitation beam L1 into a conversion beam L3, and the conversion beam L3 is reflected by the light wavelength conversion regions 1021 and 1022. When the transmission region 1023 inserts on the transmission path of the excitation beam L1, the excitation beam L1 penetrates the transmission region 1023 to form a non-conversion excitation beam L2.

The conversion beam L3 reflected by the light wavelength conversion regions 1021 and 1022 penetrates the first dichroic element 5051 and enters the first light-uniforming element 103. Therefore, the conversion beam L3 is reflected once on the transmission path between the wavelength conversion device 102 and the first light-uniforming element 103. The non-conversion excitation beam L2 from the transmission region 1023 is sequentially reflected by the mirror M1, the mirror M2, the mirror M3, and the mirror M4, then reflected by the first dichroic element 5051 and enters the first light-uniforming element 103. Therefore, the non-conversion excitation beam L2 is reflected for five times on the transmission path between the wavelength conversion device 102 and the first light-uniforming element 103. The difference in the number of times the conversion beam L3 and the non-conversion excitation beam L2 are reflected on the transmission path between the wavelength conversion device 102 and the first light-uniforming element 103 is four.

Since the difference in the number of times the conversion beam L3 and the non-conversion excitation beam L2 are reflected on the transmission path between the wavelength conversion device 102 and the first light-uniforming element 103 is 4 (even number), the long axis of the spot of the non-conversion excitation beam L2 and the long axis of the spot of the conversion beam L3 on the light incident surface 1031 of the first light-uniforming element 103 are substantially parallel to each other. With the proper configuration of the first light-uniforming element 103, the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area, so that the illumination system 500 may have good efficiency and uniformity.

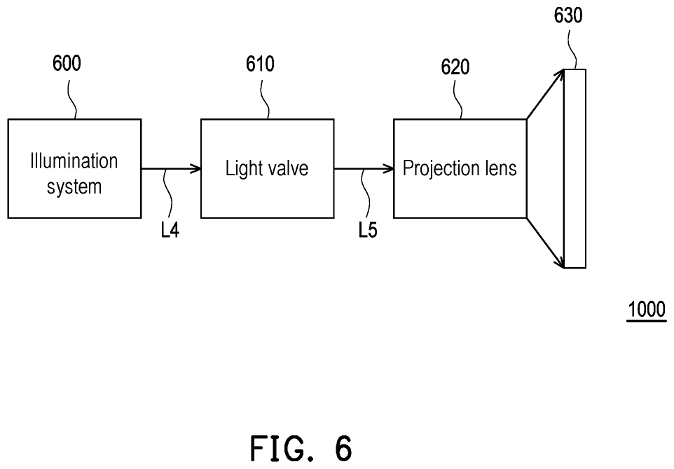

Referring to FIG. 6, the projection apparatus 1000 includes an illumination system 600, a light valve 610, and a projection lens 620. The illumination system 600 provides the illumination beam L4, and the illumination system 600 may be implemented through any one of the above-mentioned illumination system 100, illumination system 200, illumination system 300, illumination system 400 and illumination system 500. The light valve 610 is disposed on the transmission path of the illumination beam L4 to convert the illumination beam L4 into the image beam L5. The projection lens 620 is disposed on the transmission path of the image beam L5 to project the image beam L5 out of the projection apparatus 1000, for example, onto the projection screen 630 or a white wall. As mentioned above, in the illumination system 100, the illumination system 200, the illumination system 300, the illumination system 400 and the illumination system 500, the long axis of the spot of the non-conversion excitation beam L2 and the long axis of the spot of the conversion beam L3 on the light incident surface 1031 of the first light-uniforming element 103 are substantially parallel to each other, and the spot projected by the non-conversion excitation beam L2 on the light incident surface 1031 of the first light-uniforming element 103, the spot projected by the conversion beam L3 on the light incident surface 1031 of the first light-uniforming element 103, and the light incident surface 1031 may have the maximum overlapping area. As such, each illumination system may have good efficiency and uniformity. Therefore, the projection apparatus 1000 equipped with any one of the above illumination systems has high brightness, good color performance and good uniformity.

To sum up, in the illumination system provided by the embodiments of the present disclosure, the conversion beam is reflected for X time(s) on the transmission path between the wavelength conversion device and the first light-uniforming element, and the non-conversion excitation beam is reflected for Y time(s) on the transmission path between the wavelength conversion device and the first light-uniforming element, and Y−X=2N, N is a positive integer greater than or equal to 1, so that the long axes of the spots of both the non-conversion excitation beam and the conversion beam on the light incident surface of the light-uniforming element are substantially parallel to each other, match the shape of the light incident surface of the light-uniforming element, and the light combining efficiency is high. Therefore, the projection apparatus provided with the above-mentioned illumination system has high brightness, good color performance and good uniformity.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An illumination system, configured for providing an illumination beam, comprising: a light source, a wavelength conversion device and a first light-uniforming element; wherein
the light source is configured to emit an excitation beam;
the wavelength conversion device comprises at least one light wavelength conversion region and at least one transmission region, wherein the at least one light wavelength conversion region and the at least one transmission region sequentially insert on a transmission path of the excitation beam at different time periods, when the at least one light wavelength conversion region inserts on the transmission path of the excitation beam, the at least one light wavelength conversion region converts the excitation beam into a conversion beam, and the conversion beam is reflected by the at least one light wavelength conversion region, when the at least one transmission region inserts on the transmission path of the excitation beam, the excitation beam forms a non-conversion excitation beam after penetrating the at least one transmission region; and
the first light-uniforming element is disposed on transmission paths of the conversion beam and the non-conversion excitation beam, and the illumination beam is formed after the conversion beam and the non-conversion excitation beam penetrate the first light-uniforming element, wherein the conversion beam is reflected for X time(s) on a transmission path between the wavelength conversion device and the first light-uniforming element, and the non-conversion excitation beam is reflected for Y time(s) on the transmission path between the wavelength conversion device and the first light-uniforming element, Y−X=2N, and N is a positive integer greater than or equal to 1.

2. The illumination system according to claim 1, further comprising a second light-uniforming element, wherein the second light-uniforming element is disposed on the transmission path of the excitation beam, and is located between the light source and the wavelength conversion device, wherein after the excitation beam penetrates the second light-uniforming element, a spot of the excitation beam on a plane perpendicular to a transmission direction of the excitation beam is non-circularly symmetric.

3. The illumination system according to claim 2, wherein the non-conversion excitation beam forms a first spot on a light incident surface of the first light-uniforming element, and the conversion beam forms a second spot on the light incident surface of the first light-uniforming element, the first spot and the second spot are both non-circularly symmetric, and a long axis of the first spot is substantially parallel to a long axis of the second spot.

4. The illumination system according to claim 1, further comprising a light combining assembly, which is arranged on the transmission path of the conversion beam.

5. The illumination system according to claim 4, wherein the light combining assembly comprises a first dichroic element, one of the non-conversion excitation beam and the conversion beam is reflected by the first dichroic element and then enters the first light-uniforming element, and the other one of the non-conversion excitation beam and the conversion beam penetrates the first dichroic element and then enters the first light-uniforming element.

6. The illumination system according to claim 5, wherein the excitation beam penetrates the first dichroic element.

7. The illumination system according to claim 6, further comprising a light transmission assembly which comprises a plurality of mirrors, wherein the light transmission assembly is configured to satisfy the non-conversion excitation beam being reflected for Y time(s) on the transmission path between the wavelength conversion device and the first light-uniforming element.

8. The illumination system according to claim 5, wherein the excitation beam is reflected by the first dichroic element.

9. The illumination system according to claim 8, further comprising a light transmission assembly which comprises a plurality of mirrors, wherein the light transmission assembly and the first dichroic element are configured to satisfy the non-conversion excitation beam being reflected for Y time(s) on the transmission path between the wavelength conversion device and the first light-uniforming element.

10. The illumination system according to claim 5, further comprising a second dichroic element, wherein the excitation beam penetrates the second dichroic element.

11. The illumination system according to claim 10, wherein the conversion beam penetrates the first dichroic element after being reflected by the second dichroic element.

12. The illumination system according to claim 11, further comprising a light transmission assembly which comprises a plurality of mirrors, wherein the light transmission assembly and the first dichroic element are configured to satisfy the non-conversion excitation beam being reflected for Y time(s) on the transmission path between the wavelength conversion device and the first light-uniforming element.

13. The illumination system according to claim 4, wherein the non-conversion excitation beam and the conversion beam enter the first light-uniforming element after being reflected by the light combining assembly.

14. The illumination system according to claim 13, wherein the light combining assembly comprises a dichroic element and a reflective element, the non-conversion excitation beam and the conversion beam are respectively reflected by the reflective element and the dichroic element, and then enter the first light-uniforming element.

15. The illumination system according to claim 14, wherein the dichroic element is arranged along a diagonal line of the reflective element, and the reflective element is arranged along a diagonal line of the dichroic element, so the dichroic element and the reflective element are arranged in an X-shape configuration.

16. The illumination system according to claim 14, wherein when the at least one transmission region inserts on the transmission path of the excitation beam, the excitation beam is formed into the non-conversion excitation beam after penetrating the dichroic element of the light combining assembly and the at least one transmission region in sequence, the non-conversion excitation beam is reflected to the first light-uniforming element by the reflective element of the light combining assembly, when the at least one light wavelength conversion region inserts on the transmission path of the excitation beam, the excitation beam penetrates the dichroic element of the light combining assembly and is converted by the at least one light wavelength conversion region into the conversion beam, and the conversion beam is reflected by the at least one light wavelength conversion region and the dichroic element of the light combining assembly in sequence to the first light-uniforming element.

17. The illumination system according to claim 16, further comprising a light transmission assembly which is configured on the transmission path, which is between the wavelength conversion device and the first light-uniforming element, of the non-conversion excitation beam, wherein the excitation beam penetrates the dichroic element of the light combining assembly along a first direction, the non-conversion excitation beam is reflected by a first mirror of the light transmission assembly and then transmitted in a second direction, the non-conversion excitation beam is reflected by the reflective element and transmitted to the first light-uniforming element along a third direction, and the first direction, the second direction and the third direction are perpendicular to each other.

18. The illumination system according to claim 17, wherein the conversion beam is transmitted to the first light-uniforming element along the third direction after being reflected by the dichroic element.

19. The illumination system according to claim 1, further comprising a light transmission assembly which comprises a plurality of mirrors, wherein the plurality of mirrors are configured on the transmission path, which is between the wavelength conversion device and the first light-uniforming element, of the non-conversion excitation beam, and configured to guide the non-conversion excitation beam from the at least one transmission region to the first light-uniforming element.

20. A projection apparatus, comprising: an illumination system, a light valve and a projection lens, wherein the illumination system is configured to provide an illumination beam, and the light valve is arranged on a transmission path of the illumination beam to convert the illumination beam into an image beam, and the projection lens is arranged on a transmission path of the image beam to project the image beam out of the projection apparatus; the illumination system comprising: a light source, a wavelength conversion device and a first light-uniforming element; wherein
the light source is arranged to emit an excitation beam;
the wavelength conversion device comprises at least one light wavelength conversion region and at least one transmission region, wherein the at least one light wavelength conversion region and the at least one transmission region sequentially insert on a transmission path of the excitation beam at different time periods, when the at least one light wavelength conversion region inserts on the transmission path of the excitation beam, the at least one light wavelength conversion region converts the excitation beam into a conversion beam, and the conversion beam is reflected by the at least one light wavelength conversion region, when the at least one transmission region inserts on the transmission path of the excitation beam, the excitation beam forms a non-conversion excitation beam after penetrating the at least one transmission region; and
the first light-uniforming element is disposed on transmission paths of the conversion beam and the non-conversion excitation beam, and the illumination beam is formed after the conversion beam and the non-conversion excitation beam penetrate the first light-uniforming element, wherein the conversion beam is reflected for X time(s) on a transmission path between the wavelength conversion device and the first light-uniforming element, and the non-conversion excitation beam is reflected for Y time(s) on the transmission path between the wavelength conversion device and the first light-uniforming element, and Y−X=2N, and N is a positive integer greater than or equal to 1.
